(19) United States
(12) Patent Application Publication
(10) Pub. No.: US 2009/0173593 A1
(43) Pub. Date: Jul. 9, 2009

(54) Clutch Housing

(76) Inventor: I Lin, Taipei (TW)

Correspondence Address: Chung Chang, 7 Marlboro Road, Lexington, MA, 02421, US

(21) Appl. No.: 12/264,397

(22) Filed: Nov. 4, 2008

(30) Foreign Application Priority Data
Jan. 4, 2008 (TW) 97200294

(51) Int. Cl. F16D 13/00

(52) U.S. Cl. 192/113.23

(57) ABSTRACT

An improvement of the clutch housing structure, comprising a housing that fits the clutch carrier of the clutch disk, where the housing is provided with a skirt portion that embraces the clutch carrier; and a washer in rigid wall, which is fixed onto the inner side of the skirt portion of the housing, where the washer and the clutch carrier press each other to form a obstruction that characterizes high coefficient of friction, which further drives the boss to move the wheels; the target is to improve the imperfections of the prior art which includes the deformation at high temperature, or the skid and incomplete transmission by lacking of enough friction.

### BACKGROUND OF THE INVENTION

1. Field of the Invention

The present invention relates to clutch housing structures, more particularly, to one that is free of deformation subject to high temperature and not liable to skid.

2. Background of the Invention

CVT (Continuous Variable Transmission) is a fabulous power transmission system, where the utmost in advantage no doubt lies in its continuous non-gear shift, which characterizes a seamless transition during the changing of acceleration, enabling a direct and smooth transmission of the power, unlike ordinary gearshift systems, where a sizable difference between the gear ratio of its first gear and that of the second gear, which brings in the following drawbacks: considerable vibration at the moment of shifting gear, insufficient smoothness during power succession, unexpected deadlock of power transmission during shifting gear, lacking of immediate response for the accelerator, and more power consumption.

The principle for the motion of CVT is to relay the power originated from the master wheel set which is driven by the engine connecting rod, through the transmission belt activating the clutch, followed by the actuation of the clutch housing by the clutch carrier to carry the power to the boss, and eventually making the wheels moving.

In the aforesaid description, as the clutch engages a high speed revolution, it flings the clutch carrier outward for expansion which presses the skirt portion of the clutch housing that in turn drives the boss to move the wheels; therefore, the clutch housing is prone to deform by high temperature due to high speed friction or by an external force that forfeit its functionality, which again affects the efficiency of power transmission. Due to the imperfection of partial structural design, current clutch housings when in use have the following drawbacks:
1. If the clutch housing is designed to adopt substance (for instance: steel, aluminum alloy) of more rigid structure and being hard to deform at high temperature, then its coefficient of friction is for sure relatively low, and once the clutch carrier of the clutch presses to drive the clutch housing, phenomena of skidding and incomplete transmission will be aroused due to the insufficient friction for the power transmission, which gives rise to huge loss of power.
2. Otherwise, the clutch housing is designed to adopt substance (for instance: cast iron) of high coefficient of friction. Once the clutch carrier of the clutch presses to drive the clutch housing, phenomenon of skidding is not likely to happen as a result of the insufficient friction during the power transmission; on the other hand, the clutch housing made of the cast iron is relatively easier to deform subject to high temperature or external force and then to forfeit its functionality.

In view of the fact that conventional clutch housing structures do have the aforesaid imperfections, the inventor hence decided to design and improve the clutch housing structure anew, intending to improve those drawbacks and to equip the clutch housing with the trait that is hard to deform and hard to skid simultaneously.

### SUMMARY OF THE INVENTION

The objective of the present invention is to provide an improvement of the clutch housing structure, comprising a housing that fits the clutch carrier of the clutch disk, where the housing is provided with a skirt portion that embraces the clutch carrier; and a washer in rigid wall, which is fixed onto the inner side of the skirt portion of the housing, where the washer and the clutch carrier press each other to form a obstruction that characterizes high coefficient of friction, which further drives the boss to move the wheels; the target is to improve the imperfections of the prior art which includes the deformation at high temperature, or the skid and incomplete transmission by lacking of enough friction.

The novelty, traits, other objects and functionality of the present invention will be clearly comprehended by referring to the following detailed description in conjunction with the accompanying drawings.

### BRIEF DESCRIPTION OF THE DRAWINGS

FIG. 1 is a schematic diagram of the exemplified embodiment of the present invention;

FIG. 2 is an exploded view of the structure of the present invention; and

FIG. 3 is a sectional view of the structure of the present invention.

### DETAILED DESCRIPTION OF THE PREFERRED EMBODIMENTS

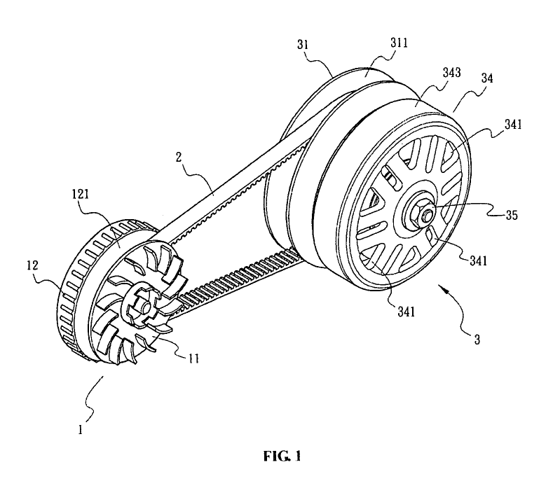

Referring to FIGS. 1 & 2, the improvement of the clutch housing structure of the present invention can be applied in a shift power transmission system; the shift power transmission system comprising a master wheel set 1, receiving driving power from engine connecting rod, which activates the clutch 3 through the transmission belt 2, and the power is transmitted to the boss 33 through the clutch disk 32, eventually to move the wheels; the master wheel set 1 is provided with a trench 121, and a belt 2 is hitched onto the trench 121, where the belt 2 has its other end encircle the clutch 3 into its trench 311; the clutch 3 is provided with a torque plate 31 and a clutch disk 32 with a plurality of clutch carriers 321, where the clutch disk 32 is embraced by a clutch housing 34.

The clutch housing 34 is designed into a hollow cylinder or a bowl shape with a hollow inside, and has a skirt portion 343; a washer 342 shaped in hollow cylinder, fixed onto the inner side of the skirt portion 343 of the clutch housing 34, where the washer 342 and the clutch carrier 321 of the clutch 32 are pressing each other.

There are a plurality of air vents 341 at its bottom or lateral face, which make the air to flow between the clutch disk 32 and the clutch housing 34;

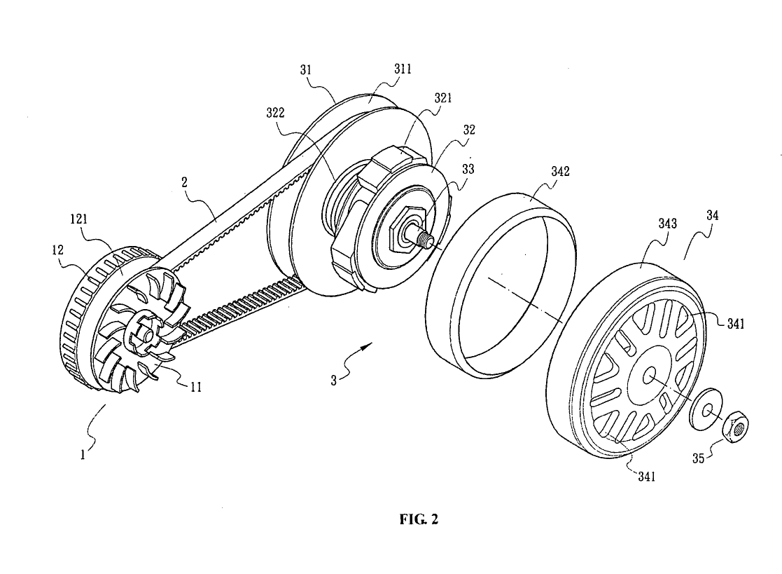

Referring to FIG. 2, FIG. 2 is an exploded view of the structure of the present invention, showing the clutch housing 34 and the washer 342 are integral parts of the clutch; the washer 342 is shaped a ring structure in the embodiment.

Prior art clutch housings 34 are prone to select the substance of being rigid in nature and hard to deform at high temperature (for instance: steel, aluminum alloy or the like substances) for all in one production, which offers the endurance to the high temperature environment brought by high revolution of the clutch disk 32, and avoids deformation at the high temperature. Therefore, to take a better thought, the clutch housing 34 of the present invention is inclined to adopt the substance of being rigid in nature and hard to deform at high temperature for production; also to position the washer 342 onto the inner side of the skirt portion 343 of the clutch housing 34, followed by pressing, welding or the like for fixing; the washer 342 is inclined to select the substance of high coefficient of friction and better heat dissipation (for instance: cast iron or the like substances) for production. The washer 342 and the clutch carrier 321 therefore form an ideal obstruction for pressing each other, and the drawbacks in the prior art like skidding and incomplete power transmission due to insufficient friction can be reduced to the minimum. Meanwhile, the close relationship of the washer 342 and the clutch housing 34 enables the clutch housing 34 to confine the structural shape of the washer 342, and also improves the washer 342 of high coefficient of friction from being deformed easily at high temperature.

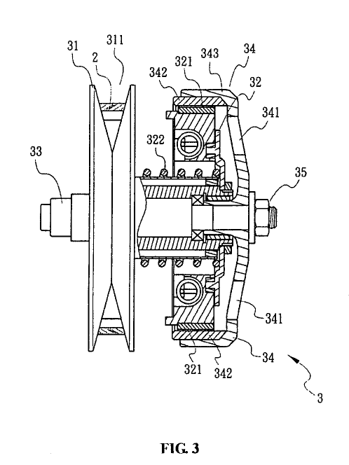

Referring to FIGS. 2 & 3, FIG. 3 is a sectional view of the structural of the present invention, showing the communion among the clutch housing 34, the washer 342 and the clutch carrier 321, where the clutch housing 34 is capping along the outer rim of the clutch carrier 321. The clutch disk 32 has its one face to engage a pinned joint with the shift spring 322 onto the boss 33, while the other end of the shift spring 322 joins a lateral face of a torque plate 31; the trench 311 of the torque plate 31 is set up with an aforementioned belt 2, where the belt 2, in the trench 311, is gripped by the torque plate 31 which is subject to the elastic force of the shift spring 322, or due to the driving force by the master wheel set 1, the shift spring 322 is pressed to enlarge the width of the trench 311 of the torque plate 31, which makes the belt 2 move back and forth in the trench 311.

Referring again to FIGS. 2 & 3, when engine is running, the weight rollers in the variator 12 will push the variator 12 to slide in a lateral direction, which enables the belt 2 in the trench 121 of the variator 12 to move back and forth in a lateral direction; the belt 2 will slide toward inner side of the trench 311 of the torque plate 31, and drive the clutch disk 32 joined with the torque plate 31 for rotating together. As the clutch 3 runs to a certain speed, it flings the clutch carrier 321 as a result of the centrifugal force, which makes the clutch carrier 321 undergoes a outward expansion, and pushes the clutch carrier 321 and the washer 342 on the inner side of the skirt portion 343 of the clutch housing 34 to press each other for revolution together. The clutch housing 34 activates the rotation of the boss 33, and the power is transmitted to the wheel shaft through a gear wheel set of fixed gear ratio.

Accordingly, the structure joined by the washer 342 of high coefficient of friction and the clutch housing 34 of rigid structure, makes the washer 342 and the clutch carrier 321 to form an obstruction for pressing each other, and makes sure the power is transmitted to the wheel shaft completely; in the prior art, as the clutch carrier 321 joins the housing skirt portion 343 made of aluminum alloy or stainless steel, the drawbacks like skidding and incomplete power transmission due to the lacking of friction can now be improved. Moreover, the structure joined by the clutch housing 34 of high temperature resistance and the washer 342 enables the clutch housing 34 to confine effectively the structural shape of the washer 342; therefore, the deformation of housing at high temperature in the prior art can then be reduced to the minimum.

Overall, the present invention offers a structure that effectively improves the prior art clutch housings; it features novel functionality with respect to the prior art, and has made substantial progress, which has fully complied with the requirements of invention patentability.

The aforesaid description is a preferred exemplified embodiment of the present invention, and it is apparent that the disclosed subject matter is not considered to be restrictive to the scope of the realization of the present invention, that is, any equivalent variations and modifications without departing from the spirit and scope of the present invention are therefore intended to be embraced.

What is claimed is:

1. A structure improvement of the clutch housing, comprising a housing of high rigid substance that caps the clutch carrier of the clutch disk; and a washer of rigid wall featuring high coefficient of friction, which is fixed onto the inner side of the housing, where the washer and the clutch carrier press each other to form a obstruction characterizing high coefficient of friction, to drive the boss.

2. A structure improvement of the clutch housing as in claim 1 wherein the clutch housing is provided with a plurality of air vents.

3. A structure improvement of the clutch housing as in claim 1 wherein the clutch housing adopts substance resistant to high temperature for production.

4. A structure improvement of the clutch housing as in claim 1 wherein the clutch housing is selected from the high rigid substance which is hard to deform for production.

5. A structure improvement of the clutch housing as in claim 1 wherein the washer is made of the cast iron or the like substance.

6. A structure improvement of the clutch housing as in claim 3 wherein the washer is made of the cast iron or the like substance.

7. A structure improvement of the clutch housing as in claim 4 wherein the washer is made of the cast iron or the like substance.

8. A structure improvement of the clutch housing as in claim 1 wherein the washer forms a hollow ring structure.

9. A structure improvement of the clutch housing as in claim 3 wherein the washer forms a hollow ring structure.

10. A structure improvement of the clutch housing as in claim 4 wherein the washer forms a hollow ring structure.

11. A structure improvement of the clutch housing as in claim 5 wherein the washer forms a hollow ring structure.

12. A structure improvement of the clutch housing as in claim 6 wherein the washer forms a hollow ring structure.

13. A structure improvement of the clutch housing as in claim 7 wherein the washer forms a hollow ring structure.

14. A structure improvement of the clutch housing as in claim 1 wherein the washer presses tightly to the clutch housing to join each other.

15. A structure improvement of the clutch housing as in claim 3 wherein the washer presses tightly to the clutch housing to join each other.

16. A structure improvement of the clutch housing as in claim 4 wherein the washer presses tightly to the clutch housing to join each other.

17. A structure improvement of the clutch housing as in claim 5 wherein the washer presses tightly to the clutch housing to join each other.

18. A structure improvement of the clutch housing as in claim 6 wherein the washer presses tightly to the clutch housing to join each other.

19. A structure improvement of the clutch housing as in claim 8 wherein the washer presses tightly to the clutch housing to join each other.

20. A structure improvement of the clutch housing as in claim 1 wherein the welding is the means to enhance the bond between the washer and the clutch housing.

21. A structure improvement of the clutch housing as in claim 3 wherein the welding is the means to enhance the bond between the washer and the clutch housing.

22. A structure improvement of the clutch housing as in claim 4 wherein the welding is the means to enhance the bond between the washer and the clutch housing.

23. A structure improvement of the clutch housing as in claim 5 wherein the welding is the means to enhance the bond between the washer and the clutch housing.

24. A structure improvement of the clutch housing as in claim 6 wherein the welding is the means to enhance the bond between the washer and the clutch housing.

25. A structure improvement of the clutch housing as in claim 8 wherein the welding is the means to enhance the bond between the washer and the clutch housing.

26. A structure improvement of the clutch housing as in claim 14 wherein the welding is the means to enhance the bond between the washer and the clutch housing.
